(19) United States
(12) Patent Application Publication
(10) Pub. No.: US 2018/0136619 A1
(43) Pub. Date: May 17, 2018

(54) Smart and Periodic Scheduling Method for Automation System

(71) Applicants: Tung Dao, Houston, TX (US); Vadim Minosyan, Houston, TX (US)

(72) Inventors: Tung Dao, Houston, TX (US); Vadim Minosyan, Houston, TX (US)

(21) Appl. No.: 15/809,177

(22) Filed: Nov. 10, 2017

Related U.S. Application Data
(60) Provisional application No. 62/420,653, filed on Nov. 11, 2016.

(51) Int. Cl. G05B 15/02; G06F 3/0484; G06F 3/0482

(52) U.S. Cl. CPC G05B 15/02; G06F 3/0482; G06F 3/04842

(57) ABSTRACT

A method and system for scheduling a device or a system of devices to perform specific functions. The system comprises of a graphical user interface (GUI) to configure the schedule data, a communication protocol to send the data to an end-device or to multicast the data to multiple end-devices, and the end-device that is able to receive the schedule data, process the data, and send electrical signals to trigger specific functions of the device based on the schedule data. The present invention reduces the complexity and effort in scheduling complex system that involves unusual scheduling requirements that include but are not limited to unbounded durations, nested functions, and asynchronous functions.

### CROSS REFERENCES TO RELATED APPLICATIONS

The present applications claims priority to the earlier filed provisional application having EFS ID 27483589 and Application No. 62/420,653, and hereby incorporates subject matter of the provisional application in its entirety.

### FIELD OF INVENTION

This invention relates to the general field of system automation and smart scheduling in the Internet of things. Particularly, the invention relates to a method and system for scheduling an electrically controllable device or a network of electrically controllable devices to automatically perform one or more actions based on specific time frames or other triggers that may be communicated within the network by other devices or sensors.

### BACKGROUND

Schedulers and timers are commonly seen in automation systems to trigger functions of electrically-powered devices in homes and industrial usages such as agriculture. Existing scheduling methods usually involve defining a start time and a stop time to trigger functions of a device or a system. Such methods incur extra effort in calculating the stop time by the user. Especially, for applications that work with activity duration, instead of start/stop time, defining a start and stop time may not be efficient. The inefficiency becomes greater when multiple activities need to run consecutively with different durations; and even more burdensome if similar multiple activities are required for several devices working together or independently. For example, if a water lawn sprinkler needs to run at the quarter pattern for 25 minutes, then at the side-strip pattern for 100 minutes, user would need to calculate the stop time for the first 25 minutes, and then calculate the stop time again for the next 100 minutes in order to enter the scheduling.

Existing scheduling methods also often limit to setting time within a day (24 hr period) only. This creates difficulty when scheduling applications of which working duration span more than 24 hours. This is a problem that exists with both common mechanical timers, as well as the newer electrical timers on the market.

In addition, existing scheduling methods are often limited to a very low time resolution. For example, mechanical timers are usually limited to 15 minutes as the shortest time to run an activity, while electrical timers are usually limited to 1 minute. Such limitation makes it difficult to apply existing scheduling methods to applications that expect a finer resolution. For example, it would not be feasible to apply existing scheduling methods to a pump system that needs to run for 20 seconds in every 24 hours or more.

In other words, existing scheduling methods focus more on time-based scheduling. A time-based scheduling method tends to seek specific time to start and end an activity. This scheduling method usually is not efficient since it guides users to figuring out the time to start and end a desired work, instead of what needs to be done and what it takes to get it done. This invention presents a method and system that address these problems and make it more efficient to schedule devices.

### SUMMARY

This invention presents a method that incorporates the time duration of device's functions into the scheduling process. The method offers a task-based scheduling concept that allows timing complex activities where different functions run back-to-back with various durations, and where the time to perform a single functions or to complete a cycle of various activities is unbounded by a 24 hr period.

The method and system of this invention involve a scheduler unit to configure and send schedule data, a receiver unit to receive and operate the schedule data, and a data transport interface for transporting information from the scheduler to the receiver. The invention also presents an innovative user experience (UX) workflow that adopts the disclosed method to simplify traditional scheduling process.

The disclosed method and system is suitable for home and industrial automation applications, where electrically-powered devices can be scheduled and then electrically triggered for performing particular functions within specific periods of time. The present invention improves existing methods and systems for being more efficient and flexible to manage complex scheduling situations.

### BRIEF DESCRIPTION OF THE DRAWINGS

Various embodiments of the invention are disclosed in the following detailed description and accompanying drawings. These drawings only depict the preferred embodiments of the invention and are not used as a mean to limit the invention from covering other embodiments that it is capable of.

FIG. 1 illustrates the task-based scheduling structure showing its simplicity in setting up the time for triggering tasks.

FIG. 2 illustrates an advance of the task-based scheduling method showing the flexibility in choosing start time.

FIG. 3 illustrates an advance of the task-based scheduling method showing the flexibility in handling nested cycles of functions.

FIG. 4 illustrates an advance of the task-based scheduling method showing the flexibility in handling parallel and asynchronous cycles of functions.

FIG. 5A illustrates a system diagram of major components showing how each component interacts with each other.

FIG. 5B illustrates the end-devices that are described in FIG. 5A with more details.

FIG. 6 illustrates a UX workflow that adopts the method and system of this invention to aid the scheduling process.

FIG. 7 illustrates a GUI implementation of the UX workflow presented in FIG. 6 to handle the use case described in FIG. 1 and FIG. 2.

FIG. 8 illustrates a GUI implementation of the UX workflow presented in FIG. 6 to handle the use case described in FIG. 3.

FIG. 9 illustrates a GUI implementation of the UX workflow presented in FIG. 6 to handle the use case described in FIG. 4.

FIG. 10 illustrates a SMS text format that implements the UX workflow presented in FIG. 6.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

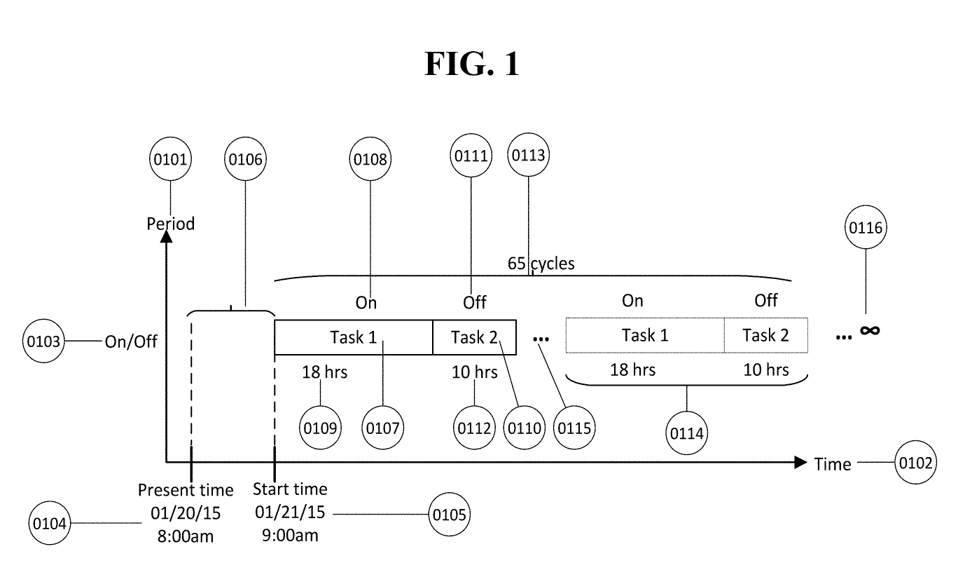

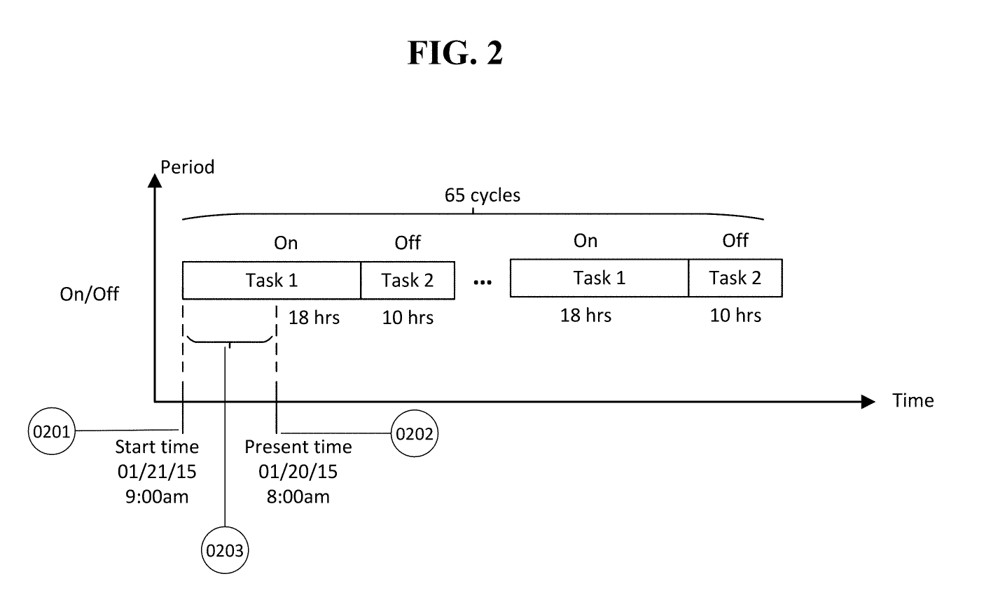

FIG. 1 illustrates the fundamentals and structure of the task-based scheduling method. The general idea of the task-based scheduling method is that functions that need to be scheduled can be organized as tasks. A series of different tasks to be triggered before the same series start again is grouped in a cycle. A schedule can repeat a cycle either a finite number of times or infinitely. With this structure, the concept of stop time is not needed and the duration for executing a particular function is not limited to a certain time frame. Instead, only the start time is needed, and then followed by a series of duration time for the tasks in the cycle to complete. In existing scheduling methods, stop time is often required and the executing duration window is often limited within a day (24 hr period). FIG. 1 uses an example application for a horticulture lighting system to demonstrate the idea of this invention. X-axis 0101 shows the time-line of activities that occurs during the scheduling process or relates to it. Y-axis 0102 shows the periods that need to be schedule. 0103 represents a period in which cycle 0114 consists of two tasks, 0107 and 0110 (Task 1 and Task 2 respectively). Task 1 (0107) when being triggered will execute functions 0108 to turn on the power of the lighting system and the system will stay on for duration 0109 of 18 hours. Task 2 (0110) when being triggered will execute functions 0111 to turn off the power of the lighting system and the system will stay off for duration 0112 of 10 hours. A schedule only needs the start time 0105, followed by 18-hour duration 0109 for Task 1 (0107) and 10-hour duration 0112 for Task 1 (0110). Gap 0106 shows the start time 0105 to occur after the present time. The method and system of this invention also has the flexibility to allow the start time to be in the past of the present time as illustrated later in FIG. 2. A cycle can be either configured to repeat for a certain number of times in a loop (cycles) (0115), for example 65 cycles (0113) in this illustration, or left to repeat infinitely (0116) until given other instruction by user.

FIG. 2 illustrates the flexibility of the method and system of this invention in allowing the start-time to occur in the past of the present time. Gap 0203 shows the gap where the start-time 0201 already occurs before the present time 0202. In this case, the process to schedule the system will remain the same by configuring the start-time followed by durations of the tasks in the cycle, without incurring further effort to adjust the start-time and stop-time as often seen with existing scheduling methods. This flexibility simplifies situations where a specific functions such as power-on has already started for some time before the actual scheduling happens.

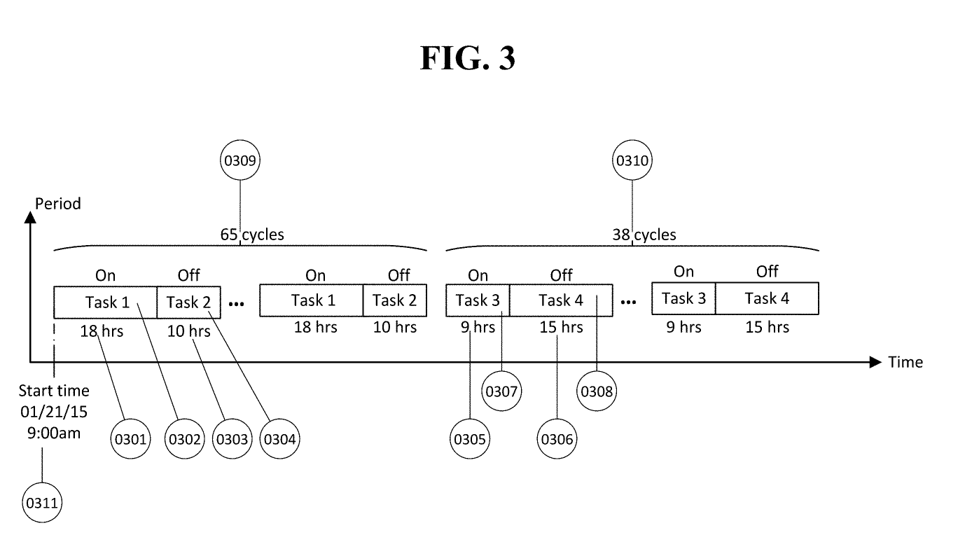

FIG. 3 illustrates an advance of this invention in handling in consistent cycles. For example, the lighting system only needs to be on as in Task 1 (0302) for 18 hours (0301) and off as in Task 2 (0304) for 10 hours in a loop of 65 cycles (0309), and then it needs to change to be on as in Task 3 (0307) for 9 hours (0305) and off as in Task 4 (0308) for 15 hours (0306) in a loop of 38 cycles (0310). In such situation, the task-based scheduling method and system allows different cycles to be nested. A schedule still only needs one start-time, followed by the configurations of the nested cycles. For example, the schedule for the lighting system in FIG. 3 only needs to know the start-time (0311) and configurations of periods 0309 and 0310.

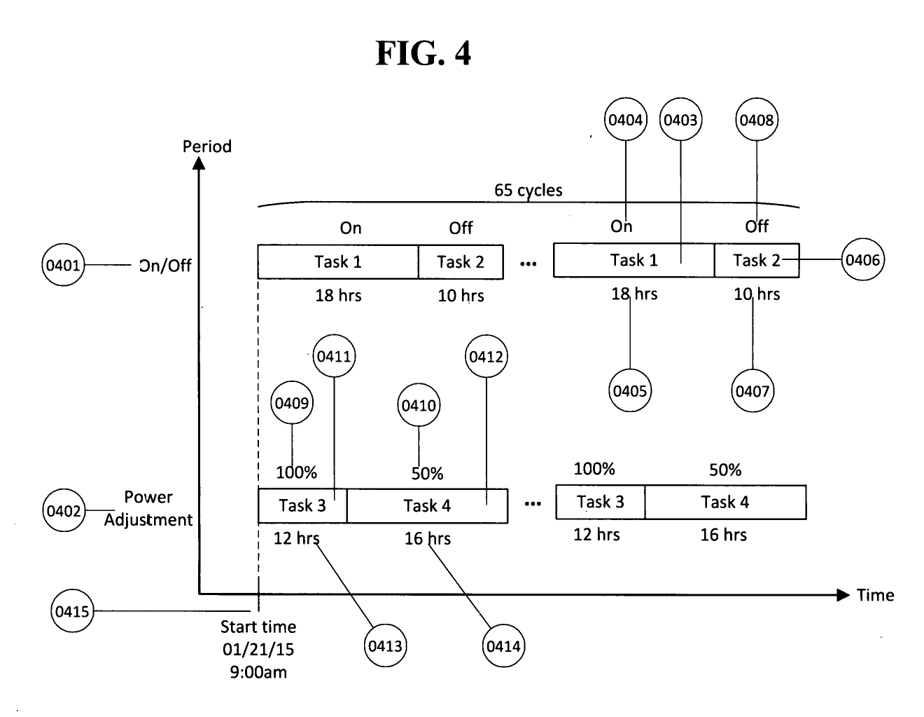

FIG. 4 illustrates an advance of this invention in handling in asynchronous functions. For example, in addition to the On/Off (0401) period as described in FIG. 1, which has Task 1 (0403) to turn on (0404) for 18 hours (0405) and Task 2 (0406) to turn off for 10 hours (0407), the lighting system also needs to run at 100% power level (0409) for 12 hours (0413) as Task 3 (0411) when the system changes to power-on at each cycle, and then at 50% power level (0410) for the rest of the cycle (0414) as Task 4 (0412). In such situation, the task-based scheduling method and system allows multiple periods to run in parallel with each other. For example, the schedule for the lighting system in FIG. 4 only needs to know the start-time (0415) and configurations of periods 0401 and 0402.

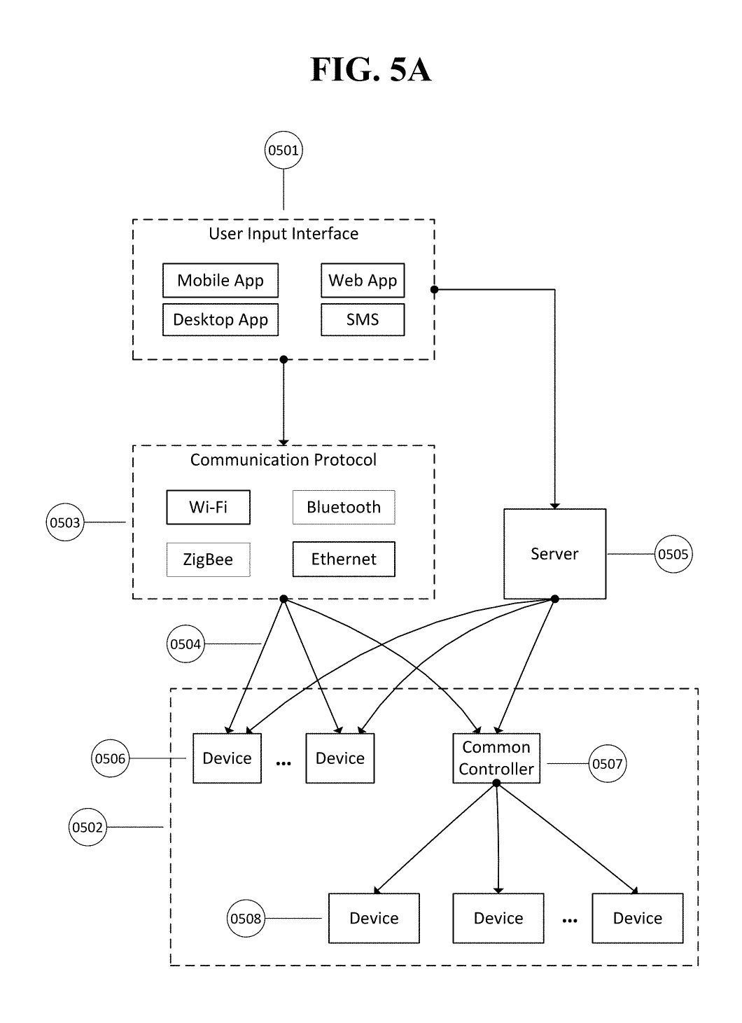

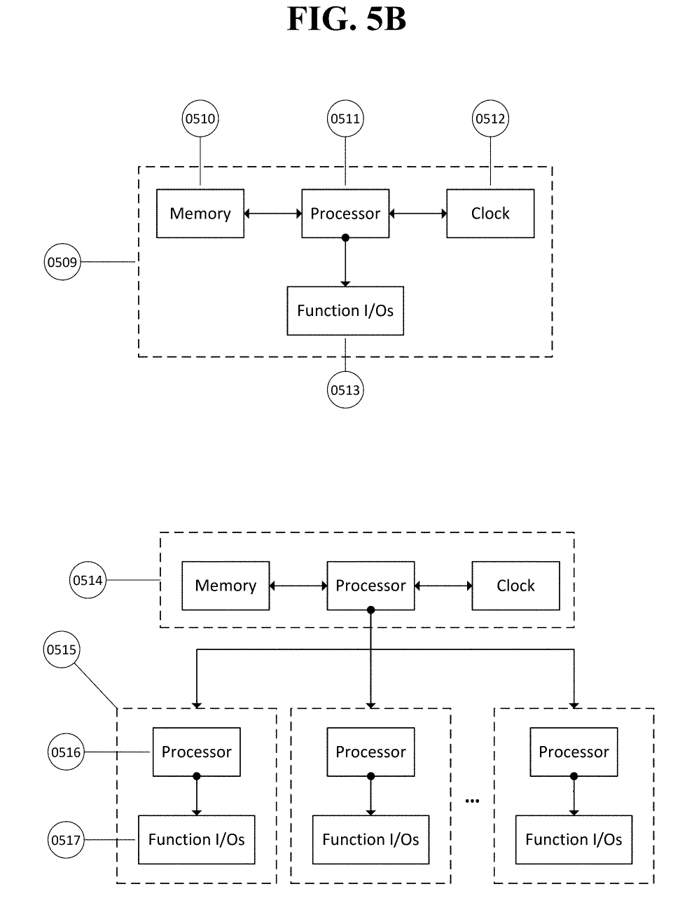

FIG. 5A illustrates the major components that an application of this invention usually has. The method and system of the invention consists of a user input interface 0501 to receive input from a user to configure a schedule. This interface can be implemented as a graphical user interface (GUI) or simply an SMS input on a mobile phone. The GUI can be applications on various computing environments, including but not limited to mobile app on a mobile phone, web app on a website, or a desktop app on a personal computer. The user input interface 0501 provides mechanism to user for entering and configuring scheduling data and sending the data to end devices 0502 via a communication protocol 0503. The communication protocol 0503 can transport data to an end-device as a direct communication 0504 between the user input interface 0501 and the device. The communication protocol sends data via a short range wireless technology including but not limited to Wi-Fi, Bluetooth, and ZigBee or via a wired technology such as Ethernet. Alternatively, the user input interface 0501 can transport data via a server 0505 if the end-devices 0502 are managed by a remote server. The communication between interface 0501 and server 0505 and between server 0505 and end-devices 0502 can happen using a technology or a combination of different technologies in the communication protocol 0503. An end-device can be a standalone and programmable system 0506 that can understand the scheduling data, process the data and execute the data itself. An end-device can also be a system of child devices in which a common controller 0507 receives the schedule configuration from the user input interface 0501. The common controller 0507 understands the scheduling data and can process the data but does not execute the specific functions on the schedule. The common controller 0507 manages the schedule and sends electrical or wireless signal to child devices 0508 and allow them to execute certain functions as scheduled.

FIG. 5B illustrates the general concept of the end devices. 0509 shows a high-level block diagram of a standalone device as presented in 0506. The major components of an end device comprises of a memory unit 0510 for storing schedule configurations, a digital clock unit 0512 for keeping track of timing, a processor unit 0511 for interacting with the memory unit 0510 and the digital clock to save/read the schedule data and to send electrical signals to function input output units (I/Os) to trigger specific functions, one or more function input/output units 0513 which perform the actual functions upon receiving triggering signals from the processor. When an end-device is a common controller as described in 0507, function I/Os are not needed as illustrated in 0514. Instead, the processor in 0514 sends triggering signals to child-devices in which each device 0515 consists of a processor 0516 to process the signals and which perform specific functions via its own function I./Os. Memory and clock components are not necessary for a child device 0515. A digital clock unit (0512) also enables scheduling to work with very fine resolution, such as seconds or less if desired.

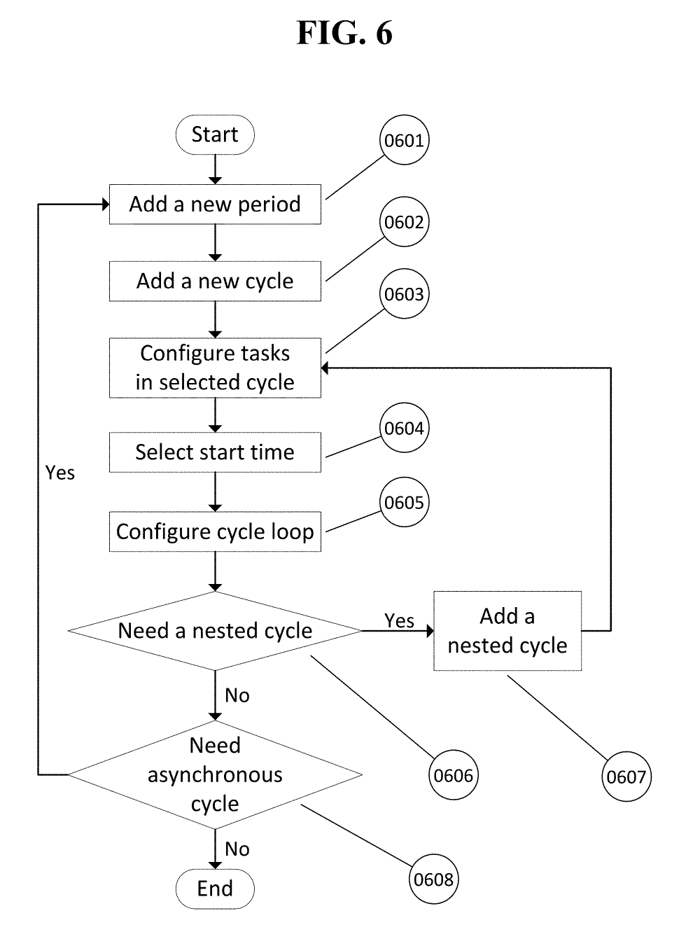

FIG. 6 illustrates a UX workflow that implements the task-based scheduling method and system. This UX workflow is a graphical presentation of the user input interface 0501 that allows a user to enter and configure scheduling data. A user usually starts with creating a new schedule period as in step 0601. In step 0602, user adds a schedule cycle to the period created in step 0601. This schedule cycle contains tasks that a device or a system of devices may need to execute. In step 0603, user configures these tasks for how much time each task needs to perform a specific functions. In step 0604, user selects a start time that the first task in the configured schedule begins to execute. As illustrated in FIG. 1 and FIG. 2, this start-time can be either in the past or the future of the present time. In step 0605, user configures whether the selected cycle in the selected period repeats for a certain number of times or infinitely. In step 0606, if user needs to create another cycle within the selected period that needs to run after the cycle that has previously been created in step 0602, user can go to step 0607 to add a nested cycle and continue with step 0603. If user does not need to add a nested cycle, user continues to step 0608. In step 0608, if a specific functions needs to run asynchronously from the functions scheduled in the period that has previously been created in step 0601, user can go back to step 0601 to add a new period and then follow the similar process again. If no other functions needs to be scheduled, the workflow ends after step 0608.

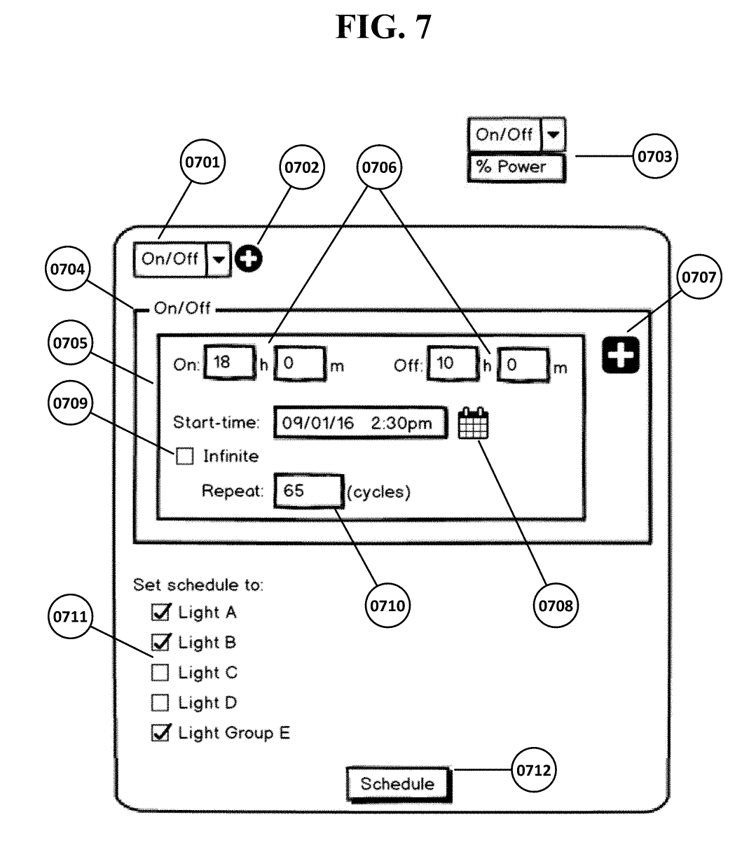

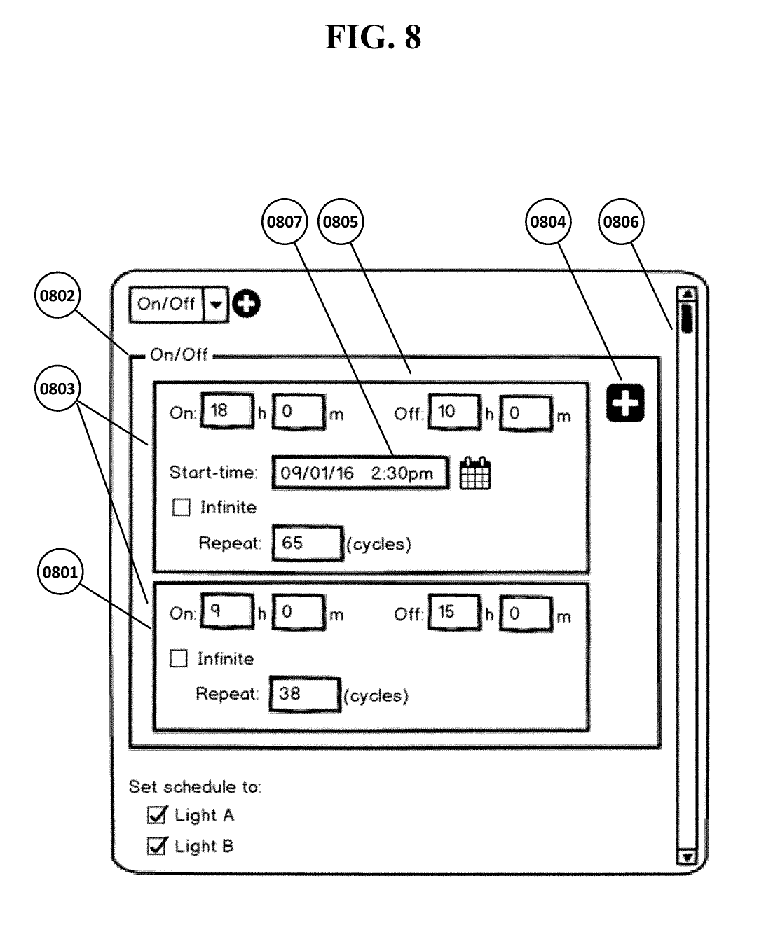

FIG. 7 illustrates a control application implementation of this invention that adopts the UX workflow as illustrated in FIG. 6 and handles the use case as presented in FIG. 1. This application consists of a GUI that allows user to enter and configure schedule data. A user starts the workflow by selecting a particular period in the drop-down list 0701. In the example in FIG. 7, this drop-down list consists of two different periods On/Off and % Power as showed in the expanded version 0703. After selecting a desired period to work with, user selects the add-button 0702 to create a new period configuration box 0704. By default, the system also creates a default cycle 0705 within period 0704, after the period is added. Then, the user enters the running durations 0706 for the On and Off tasks to program how long the power of the lighting system will stay on and off when the schedule starts to trigger. The date-time picker graphical control 0708 allows the user to configure when the first power-on activity is triggered, which also means the start-time of the selected period 0704. As illustrated in FIG. 1 and FIG. 2, this start-time can be either in the past or the future of the present time when the user is using the application to configure the schedule. Check-box 0709 allows the user to select whether the cycle 0705 will run infinitely within the period 0704 or only for a certain number of times. If the check-box 0709 is selected, the input field 0710 will not be available to the user. If the check-box 0709 is not selected, the user can enter the number of cycles to repeat cycle 0705 into the input field 0710. List 0711 contains the devices that the control application can detect within the range of communication it is able to reach. This list shows both stand-alone devices such as Light A and Light B, and groups of devices that are managed by a common controller such as Light Group E. The user selects the target devices by setting a check-mark on the items in the list 0711 to send the schedule configuration data to the devices later. After the user completes configuring all information, the user selects the button 0712 to send the schedule data to the selected devices. The user can also selects the add-button 0707 to add a nested cycle configuration to the period 0704. The illustration of the situation with nested cycle is discussed in the detailed description of FIG. 8.

FIG. 8 illustrates the control application described in FIG. 7 after the user selects the add-button 0804, which is the same as the add-button 0707 in FIG. 7. The schedule configuration in FIG. 8 is also an example of the use case discussed in the detailed description of FIG. 3. When the user selects the add-button 0804, the system adds a nested cycle 0801 below the default cycle 0805 that has previously been created as described in FIG. 7. If user continues to select the add-button 0707, similar nested cycles to 0801 will be added to the cycle stack 0803 inside the period 0802. A scroll-bar 0806 becomes visible if the screen resource is running out. In the configuration area of the nested cycle 0801, most of the input fields are the same as in the configuration area of the default cycle 0805 except for the start-time configuration 0807. By removing the need of the start-time in the nested cycles, the system has simplified the scheduling process and allowed the user to focus only on engineering principles of the lighting system, which is how long the system needs to power on and off, without worrying what time it needs to start again on different cycles.

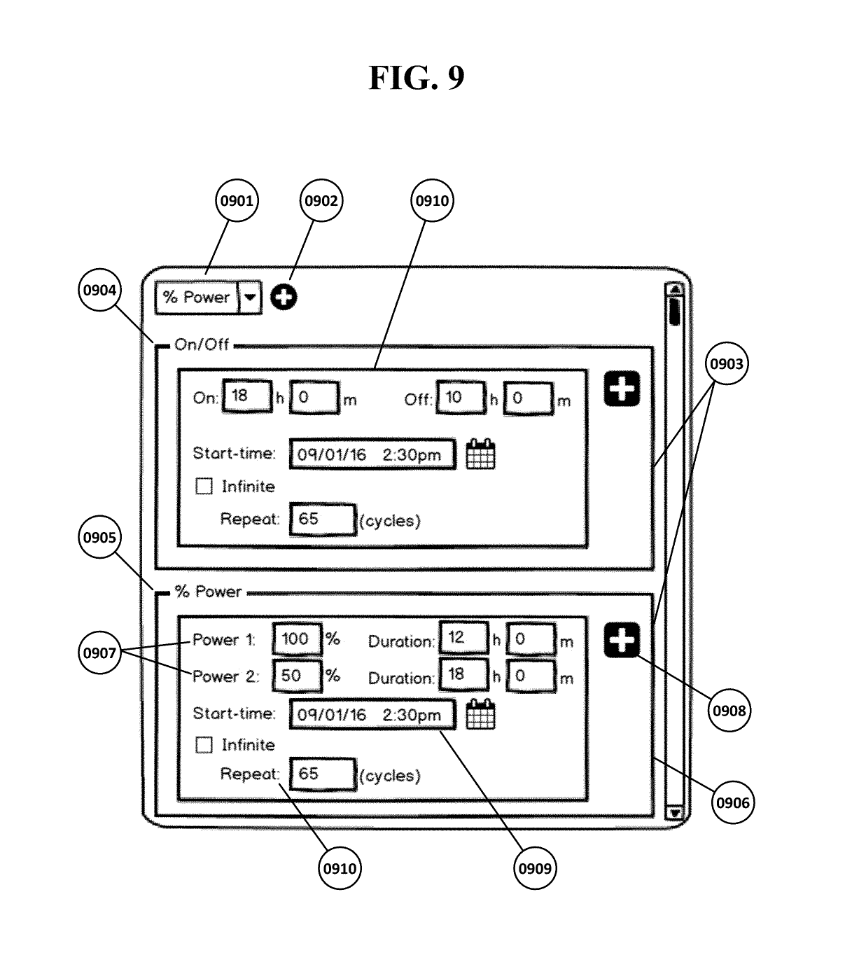

FIG. 9 illustrates the control application described in FIG. 7 when asynchronous periods are needed. After the user completes configuring the schedule in FIG. 7, the user can create another period to control the power level of the lighting system. The user achieves this by selecting the % Power period in the drop-down list 0901, which is the same as 0701 in FIG. 7, and then selecting the add-button 0902, which is the same as 0702 in FIG. 7, to create a new % Power period 0905. Then, the system will adds the period 0905 below the On/Off period 0904 in the period stack 0903. The system will also add a default cycle 0906 inside the period 0905 for configuring the power level. In the cycle 0906, input fields for the start-time 0909, the redundancy of the cycles 0910, and the add-button 0908 for adding nested cycles show up again as in the default cycle 0910 of period 0904, while the input fields 0907 are specific to the % Power period 0905 to allow configuring the power level of the lighting system. The organization of the graphical interface in FIG. 9 allows the functions to turn on and off power of the lighting system and to adjust the power level of the system to run independently while still performing specific tasks at desired schedule. Such system also makes it flexible and dynamic to handle more complicated schedule where more nested cycles or asynchronous activities are desired.

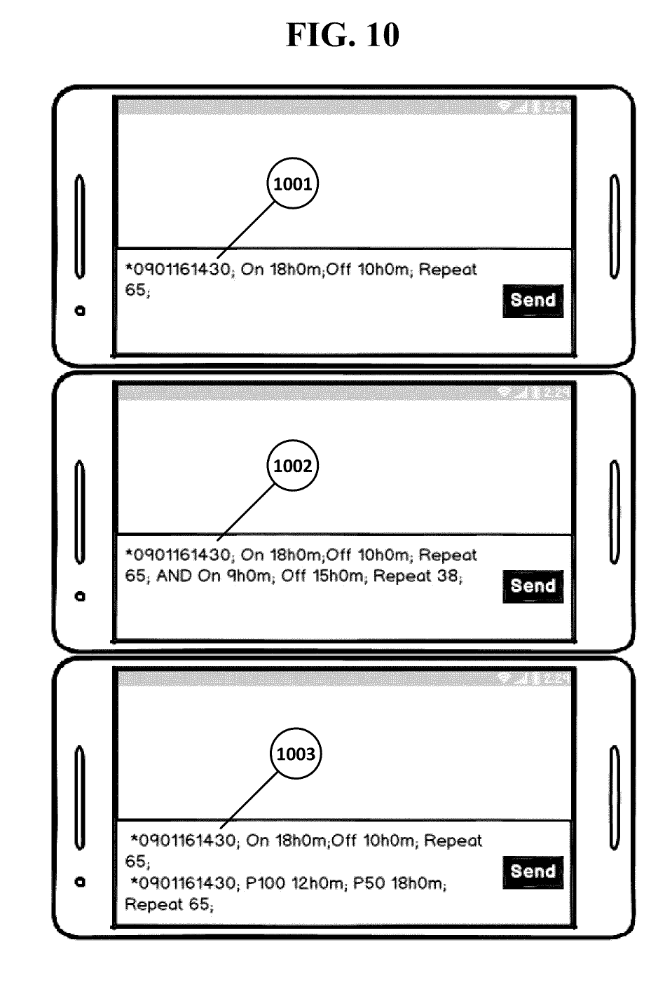

FIG. 10 illustrates a text format which enables SMS contents to be sent from a mobile phone to the processor 0511 as presented in FIG. 5B and allows the processor to understand the contents and interpret them into programmable schedule data. 1001 shows the basic format which starts with an asterisk character to indicate starting of a new period configuration, then the start-time in the format of ‘MMddyyhhmm’, a cycle's durations of power-on and power-off tasks, and the repetition of the cycle. 1002 adds a nested cycle to the same period presented in 1001 by using the keyword ‘AND’ followed by task durations for power-on and power-off in the nested cycle, and then the repetition of the nested cycle. 1003 adds a second period to the same schedule as 1001. This second period is asynchronous to 1001 and is presented by continuing the text content of 1001 with another asterisk to indicate a separate period to be process, followed by the start-time of this new period, the cycle's durations of power levels at 100% and 50%, and the repetition of the second period. When the processor 0511 in FIG. 5B receives a text content similar to what is illustrated in FIG. 10, the processor will parse the content and convert them into digital information that can be saved to the memory 0510 and synchronized with the clock 0512 in FIG. 5B.

The disclosed embodiments are illustrative, not restrictive. While specific configurations of the task-based and periodic scheduling method have been described, it is understood that the present invention is not limited to these specific embodiments. There are many alternative implementations of the invention.

Definitions

The disclosed definitions only serve as a means of providing more details to certain terminology used to describe the invention, and are not limiting the invention to any particular claim.

A. Schedule: is a collection of time information which enables programmable devices and systems to understand and setup triggering specific functions at specific time, and which can be presented in a graphical means that a human can understand and interact with via a user interface.

B. User Interface: is a graphical presentation on an electrically powered device which allows user to view, configure, and submits information.

C. User experience (UX) workflow: is broadly defined as a process of arranging graphical elements and user interactions of an application at an operational level without defining specific look and feel of the application.

D. Processor: is broadly defined as a computing unit that is programmable to perform certain activities digitally.

E. Function input/output (I/O): is broadly defined as a hardware unit which is able to receive and return electrical signals and is able to perform specific function upon receiving input electrical signals.

F. ‘MMddyyhhmm’: is a date-time format that comprises of 2 digits of the month, 2 digits of the day, 2 digits of the year, 2 digits of the hour, and 2 digits of the minute.

1. A method for scheduling an electrically-powered device or a system of electrically-powered devices to perform functions that can be triggered by electrical signals, the method comprising:
selecting a starting point for a schedule period, wherein the starting point can be either in the past or the future of the present time when the scheduling configuration is being created,
ability to refine time/task durations to increments of seconds
defining a cycle of consecutive durations in which each duration associates with the run-time of a specific function within the period,
assigning either a discrete number or an infinite redundancy to the repetition of the cycle within the period to form a cycle loop,
defining consecutive cycle loops within the period, and
defining asynchronous periods to perform one or more sets of functions in parallel with each other period.

2. A user interface system of claim 1 for managing the schedule configuration, the system comprising:
a visualization means which enables grouping consecutive cycle loops in an ordering hierarchy, and
a graphical presentation which enables displaying a comparative visualization of asynchronous periods.

3. A method for applying an identical schedule configuration to multiple devices in a single user submission, the method comprising:
a graphical user interface which enables a user to select one or more devices from a collection of reachable devices,
a detection system which allows detecting reachable devices and populating the devices onto the graphical user interface,
a submission means which allows the user to request sending the schedule configuration to the selected devices, and
a software processor which sends the schedule configuration to every device in the selected devices.
